(19) United States
(12) Patent Application Publication
(10) Pub. No.: US 2026/0187709 A1
(43) Pub. Date: Jul. 2, 2026

(54) AUTOMATED SYSTEM FOR INTELLIGENT SELLING ASSISTANCE

(71) Applicant: eBay Inc., San Jose, CA (US)

(72) Inventors: Prashant Ashok, San Jose, CA (US); Srividya Balasubramanian, Fremont, CA (US); Ping Chen, San Jose, CA (US); Jessie Du, San Jose, CA (US); Anton Ganeshalingam, Sequel, CA (US); Md Aeinul Islam, San Jose, CA (US); Denys Korovets, San Jose, CA (US); Shrivatsan Navalpakkam, San Jose, CA (US); Mei Qin, San Jose, CA (US); Ankita Sharma, San Jose, CA (US); Divyank Sharma, Gilroy, CA (US); Syed Musthafa Sikkander, Fremont, CA (US); Kenna Emily Wang, Campbell, CA (US)

(21) Appl. No.: 19/001,919

(22) Filed: Dec. 26, 2024

(51) Int. Cl. G06Q 30/0601; G06F 16/35

(52) U.S. Cl. CPC G06Q 30/0643; G06F 16/35; G06Q 30/0613

(57) ABSTRACT

An input, including information about an item to be published on the publication platform, is received from an interactive interface of a publication platform. The information about the item includes item elements related to the item. A semantic relationship between two or more of the item elements related to the item is identified based on receiving the input. The two or more item elements are grouped into a semantic group based on the semantic relationship. A listing for the item is published on the publication platform based on the two or more item elements in the semantic group.

### TECHNICAL FIELD

Embodiments of the present disclosure relate generally to automated item listing and selling on publication platforms (e.g., e-commerce platforms) and, more particularly, but not by way of limitation, to methods and systems for processing polymodal input (e.g., multiple types of input) to identify sellable items, semantically group related items, and provide comprehensive selling assistance.

### BACKGROUND

Publication platforms, such as e-commerce platforms, enable users to list and sell items online. However, conventional platforms require sellers to manually create listings, identify item categories, write descriptions, and determine shipping requirements for each item they want to sell. This manual process is time-consuming and can be particularly challenging for casual sellers or small businesses managing multiple items.

Traditional listing methods require sellers to separately photograph items, manually upload images, enter product details, and create individual listings for each item. This approach is especially inefficient when sellers have multiple items to list or when items have multiple views or surfaces that need to be properly matched and organized. Additionally, sellers often struggle with organizing and grouping related items effectively, generating appropriate promotional strategies, and ensuring proper item categorization. The lack of automated assistance in these areas can lead to suboptimal listing quality and reduced sales effectiveness.

The challenge is even more significant for sellers who have diverse inventories or need to list multiple items simultaneously. Without automated tools for processing various types of input (such as photos, videos, or audio descriptions) and intelligently organizing listing information, sellers must spend considerable time carefully managing each aspect of the selling process, from listing creation to shipping preparation. The limited guidance on packaging and shipping requirements in conventional platforms can result in improper packaging and potential damage during transit.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system, according to various examples of the present disclosure.

FIG. 2 is a diagram illustrating an example interactive interface for uploading polymodal input on a publication platform, according to various examples of the present disclosure.

FIG. 3 is a diagram illustrating an example photo input of items to be published on the publication platform, according to various examples of the present disclosure.

FIG. 4 is a schematic diagram illustrating an example voice input of items to be published on the publication platform, according to various examples of the present disclosure.

FIG. 5 is a diagram illustrating an example interactive interface showing identified, grouped, and categorized items on the publication platform, according to various examples of the present disclosure.

FIGS. 6 and 7 are example photo inputs of the front and back surfaces of items to be published on the publication platform, according to various examples of the present disclosure.

FIG. 8A is a diagram illustrating an example interactive interface showing identified, grouped, and categorized items on the publication platform, according to various examples of the present disclosure.

FIG. 8B is a diagram illustrating an example popup interactive interface showing enlarged views of the grouped surfaces of individual items, according to various examples of the present disclosure.

FIGS. 9A-9C are flowcharts illustrating an example method for processing polymodal input and generating listings on the publication platform, according to various examples of the present disclosure.

FIG. 10 is a block diagram illustrating a representative software architecture, which may be used in conjunction with various hardware architectures herein described, according to various examples of the present disclosure.

FIG. 11 is a block diagram illustrating components of a machine able to read instructions from a machine-readable medium and perform any one or more of the methodologies discussed herein, according to various examples of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Various embodiments include systems, methods, and non-transitory computer-storage media for processing polymodal input to identify and list items on a publication platform (e.g., an e-commerce platform). The polymodal input may include photos, videos, audio recordings, text, spreadsheets, etc. The system processes these various input types using artificial intelligence models to identify sellable items, extract item information, and create automated listings. For each identified item, the system can determine dimensions, weight, and other physical characteristics either based on the polymodal input or by querying a database.

When processing the polymodal input, the system employs a trained artificial intelligence (AI) model to extract and synthesize information (e.g., item elements) from different input formats. The system processes video input by extracting individual frames and applying object detection algorithms to identify sellable items within each frame. For audio input, the system employs natural language processing to interpret verbal descriptions and convert them into structured item data. The AI models are trained to provide different processing instructions based on the input format, allowing for optimal extraction of information from each type of input. The system analyzes the processed information using multi-modal large language models to identify semantic relationships between items based on various factors such as category taxonomy, physical characteristics, or related surfaces of the same item. A semantic relationship refers to a meaningful connections or associations between items, based on their attributes, context, or shared characteristics. The semantic relationship may involve identifying and establishing links between items that convey information about their similarities, differences, categories, or complementary aspects. In some examples, the semantic relationship may include but is not limited to a category-based relationship (e.g., a t-shirt and a jacket being semantically related as “clothing items), an attribute-based relationship (e.g., a red handbag and a pair of red heels being semantically related as “color: red”), a complementary relationship (e.g., a dining table and a set of chairs being semantically related as a dining set, an alternative relationship (e.g., different brands or models of smartphone being semantically related as alternatives under “mobile device), a part-to-whole relationship (e.g., a car tire being semantically related to a car as a “part to whole” relationship), a stylistic relationship (e.g., a modern sofa and a modern coffee table being semantically related as “theme: modern”), a usage context relationship (e.g., hoking boots, a backpack, and a water bottle being semantically related as outdoor gear), a brand-based relationship (e.g., a smartphone, a smartwatch, and a earbuds from the same brand being semantically related as “X brand”), etc. Based on these identified relationships, the system creates semantic groups (e.g., clusters or collections of items'information in forms of computational models, ontologies, or metadata based on the identified semantic relationship) that organize items in meaningful ways, such as grouping items by category (e.g., auto parts, children's books), grouping multiple views of the same item, or grouping related items that might be published together. For example, the system can automatically match and group the front and back surfaces of trading cards even when presented in random order. The system employs trained AI models to synthesize information from multiple input sources to generate accurate and detailed listing content. For items with multiple views, the system automatically organizes and includes all relevant images in the appropriate order.

The system leverages the processed input and semantic grouping to automatically generate comprehensive listing information. For each item or group of items, the system determines appropriate categories by querying databases based on the identified item elements. The system automatically generates titles and descriptions that accurately reflect the item characteristics and identifies relevant item specifics based on the category taxonomy. The system also determines shipping dimensions and options based on the identified physical characteristics of the items. For grouped items, the system can generate promotional content, such as category-specific coupon codes, with the ability to automatically adjust discount levels based on item categories and market conditions. A user can also manually adjust discount levels. Additionally, the system provides detailed packaging and shipping guidance tailored to each item's characteristics, including step-by-step instructions for proper packaging based on the item's dimensions, weight, and category. The system analyzes the physical characteristics of each item to recommend specific packaging materials, box sizes, and protective measures to prevent transit damage. All of these automated features can be reviewed and modified by the seller through an interactive interface, allowing for customization while maintaining the efficiency of the automated process.

The present disclosure provides significant technical improvements over conventional publication platforms. As mentioned above, traditional platforms require sellers to manually create listings, enter product details, and determine shipping requirements for each item individually. In contrast, the disclosed system automates these processes through intelligent processing of polymodal input and semantic grouping of items. The system's automatic identification and grouping capabilities eliminate the need for sellers to manually organize and categorize items, while its automated listing generation and shipping guidance features streamline the entire selling process. These technical improvements significantly reduce the time and effort required for sellers to list and sell items while ensuring comprehensive and accurate listing information.

Reference will now be made in detail to embodiments of the present disclosure, examples of which are illustrated in the appended drawings. The present disclosure may, however, be embodied in many different forms and should not be construed as being limited to the embodiments set forth herein.

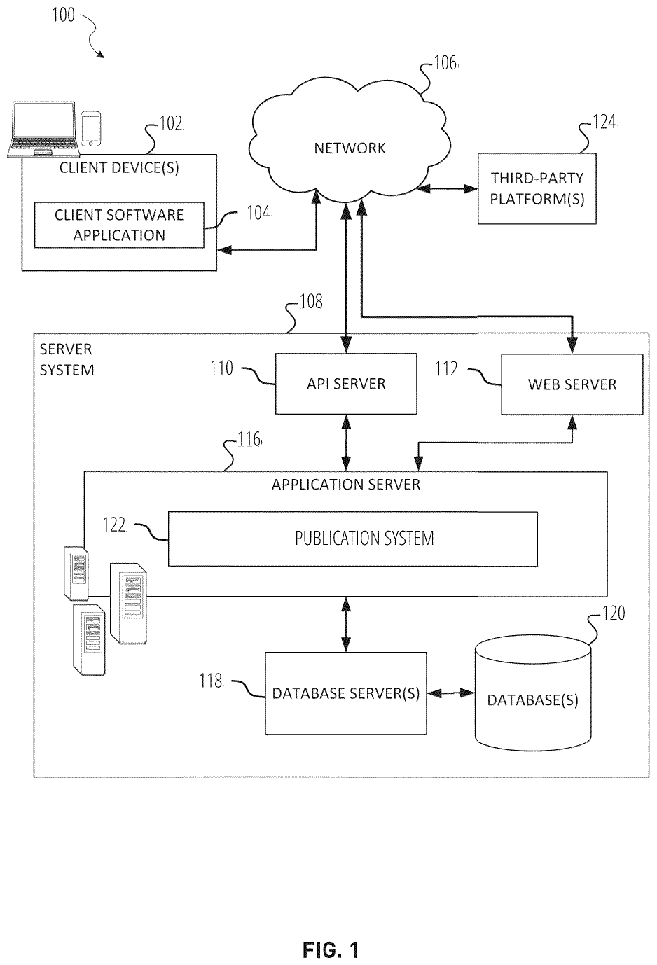

FIG. 1 is a block diagram showing an example data system 100 that includes a publication system 122 (also referred to as system 122), according to various embodiments of the present disclosure. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via the network 106. Accordingly, the client software application 104 can communicate and exchange data with the server system 108 via the network 106.

The server system 108 provides server-side functionality via the network 106 to the client software application 104. While certain functions of the data system 100 are described herein as being performed by the publication system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the publication system 122. Such operations include transmitting data from the publication system 122 to the client software application 104, receiving data from the client software application 104 at the publication system 122, and the publication system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 are coupled to an application server 116, which hosts the publication system 122. The application server 116 is communicatively coupled to a database server 118, which facilitates access to a database 120 that stores data associated with the application server 116, including data that may be generated or used by the publication system 122.

The publication system 122 interfaces with the client software application 104 through the network 106, enabling users to upload polymodal input and manage listings through interactive interfaces. The publication system 122 coordinates with database server(s) 118 to store and access data in database(s) 120 for querying item categories, retrieving dimensions and weights, and managing listing information. Through integration with third-party platforms 124, the publication system 122 facilitates enhanced services like seller research, tax structuring, and financial management. The publication system 122 may access AI models stored remotely in remote storage or domestically in the data system 100 (e.g., database 120). The AI models may be trained by the publication system 122, another internal system, or an external system. The publication system 122 may execute trained AI models to process the polymodal input. Alternatively, the model's training and execution may be performed by another system in the data system 100.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108 or the publication system 122 may extract user data from one or more third-party platforms 124 (e.g., third-party social media platforms).

Through one or more web-based interfaces (e.g., web-based user interfaces), the web server 112 can support various functionality of the publication system 122 of the application server 116.

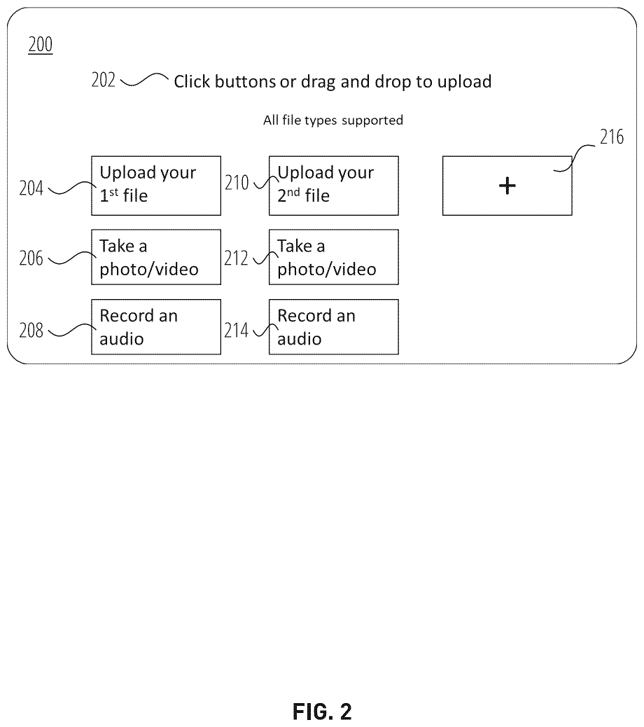

FIG. 2 is a diagram illustrating an example interactive interface 200 for uploading polymodal input on a publication platform, according to various examples of the present disclosure. The interactive interface 200 includes instructions 202 that guide users through the upload process. The instructions 202 may indicate that users can either click buttons or drag and drop files to upload their content. The interface 200 may be designed to be intuitive and user-friendly, accommodating both experienced and novice publishers (e.g., sellers). However, the layout and configurations of the interactive interface 200 are not limiting.

The interactive interface 200 provides multiple input options. Upload buttons 204 and 210 allow users to upload their first and second files, respectively, from their local storage. These buttons 204 and 210 support various file formats, enabling sellers to upload existing photos, videos, documents, or spreadsheets. In some examples, the interactive interface 200 includes additional buttons for uploading from shared drives. As another example, the interactive interface 200 includes an input field for the user to input text. Camera buttons 206 and 212 enable users to capture photos or record videos directly through the interactive interface 200 using their device's camera. Audio recording buttons 208 and 214 permit users to record verbal descriptions of their items. In some examples, publication system 122 may call the API of the device's camera or microphone to gain the permission of these devices. The interactive interface 200 may include a plus button 216 that dynamically expands the input, allowing users to add more files as needed. The interactive interface 200 may also provide real-time feedback as files are uploaded or content is recorded. For example, when a user captures photos through camera buttons 206 and 212, the interactive interface 200 may display thumbnails of the captured images. Similarly, when recording audio through buttons 208 and 214, the interactive interface 200 may show audio waveforms or recording duration.

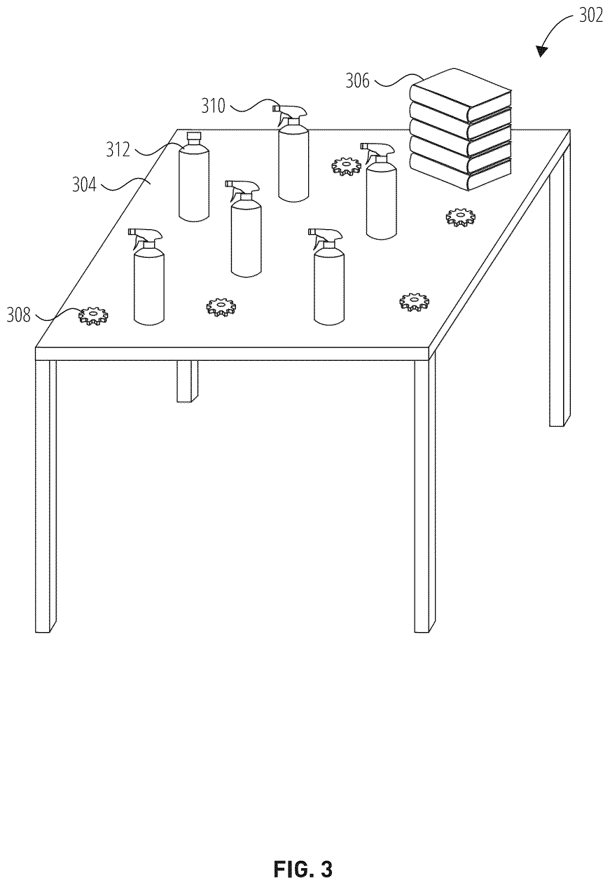

FIG. 3 is a diagram illustrating an example photo input 302 of items to be published on the publication platform, according to various examples of the present disclosure. The photo input 302 shows multiple items placed on a table 304, including several books 306 (specifically, three copies of Book A and two copies of Book B), five motor gears 308, five leather cleaners 310, and a water bottle 312.

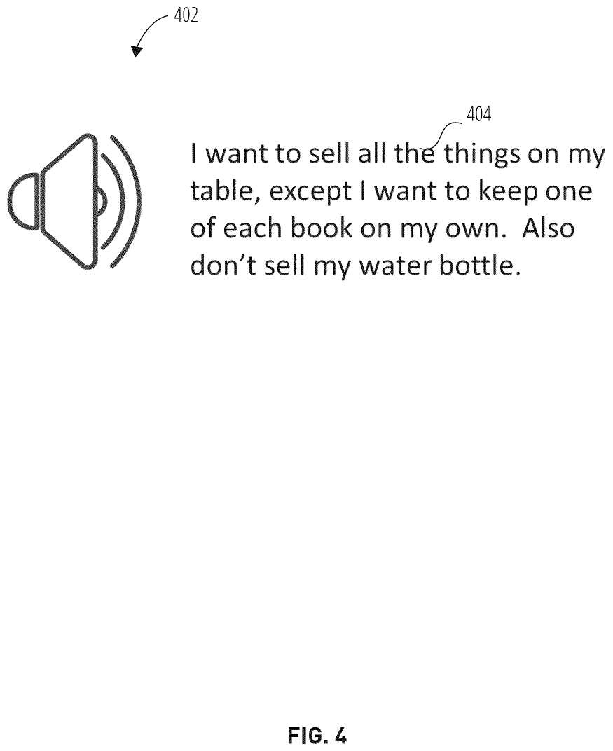

FIG. 4 is a schematic diagram illustrating an example voice input 402 of items to be published on the publication platform, according to various examples of the present disclosure. The diagram includes text 404 corresponding to the voice input, which states, “I want to sell all the things on my table, except I want to keep one of each book on my own. Also, don't sell my water bottle.” It should be noted that this is a schematic representation, as audio tracks are not typically visible in actual implementations.

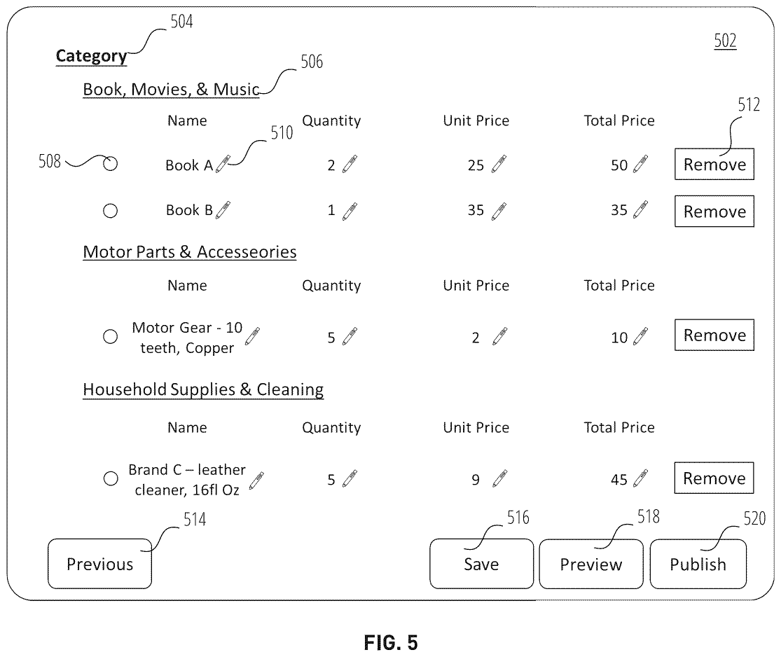

The items shown in the photo input 302 of FIG. 3 correspond to the items mentioned in the voice input 402 of FIG. 4. In example embodiments, the system can process both visual and audio input to identify and organize items, including randomly placed items as shown in FIG. 3. For example, while the water bottle 312 appears visually similar to the leather cleaner 310, the system can distinguish between them using its trained AI models. The table 304 serves as the surface on which all items are placed, corresponding to the reference in the voice input 402 about “things on my table.” The system can process this polymodal input to understand that while all items are photographed, the water bottle 312 should be excluded from the listing based on the voice instruction, and one copy of each book should be excluded from the listing. The system's trained AI models can accurately identify and categorize each item despite their random placement, enabling automatic generation of listings for two copies of Book A, one copy of Book B, five motor gears, and five leather cleaners. An example interactive interface showing these identified, grouped, and categorized items may be found in FIG. 5 and descriptions thereof.

Merely by way of example, an image recognition model based on, for example, convolutional neural networks (CNNs) or vision transformers (ViTs) is trained on a large and diverse dataset of labeled images, enabling it to recognize objects regardless of their positioning, orientation, or environmental conditions. During training, the model detects and segments objects within images, outputting class probabilities and spatial coordinates (bounding boxes) for each detected object. Meanwhile, a speech-to-text model or audio processing model built with, for example, recurrent neural networks (RNNs), transformers, or automatic speech recognition (ASR) converts voice commands, like “exclude this item” or “count one unit of this object,” into actionable tokenized representations. These visual and auditory models are then integrated into a multimodal generative AI system, such as an LLM, where both the image and voice data are fused into a unified representation for further processing. This fusion may be achieved using multimodal transformers or cross-attention mechanisms that align and map the visual and auditory features to a shared latent space. It should be noted that other models may be used, and the above-listed example models may be separated into sub-models or combined with other models. These variations are also within the protection scope of the present disclosure.

FIG. 5 is a diagram illustrating an example interactive interface 502 showing identified, grouped, and categorized items on the publication platform, according to various examples of the present disclosure.

The interactive interface 502 includes a main section 504 that organizes and displays items identified from polymodal input, such as the photo input 302 and voice input 402 shown in FIGS. 3 and 4. The main section 504 presents items in a structured format after the system processes and analyzes the input using trained artificial intelligence models. For example, from the randomly placed items shown in photo input 302, including books 306, motor gears 308, and leather cleaners 310, the system first identifies individual items and their characteristics and then organizes them into appropriate categories.

The interactive interface 502 organizes items into category subsections 506 based on the platform's taxonomy. Different items of the same category may be grouped into the same semantic group and listed under the same category heading. For example, the “Book, Movies, & Music” category includes both Book A and Book B identified from the photo input 302, while the “Motor Parts & Accessories” category contains the motor gears 308, and the “Household Supplies & Cleaning” category includes the leather cleaners 310. The system first identifies these items individually using AI models, then semantically groups them based on their relationships and characteristics, and finally categorizes them according to the platform's taxonomy.

For each identified and grouped item, the interactive interface 502 provides comprehensive management options. Selectable options 508 allow users to specify which items should be published or removed. In some examples, the interactive interface 502 may display the excluded books and water bottles with the corresponding option 508 unselected by default. Alternatively, as presently shown in FIG. 5, these items are not displayed in the interface 502 at all. In some examples, unsellable items (e.g., wall, floor, celling, window) in an image may be recognized and excluded. Additional items can be added if they are not listed properly. A pen-shaped icon 510 enables users to edit item details, such as quantities, specifications, or pricing. Remove button 512 provides a quick way to exclude items from the listing, which is particularly useful when processing polymodal input that may include items not intended for sale.

The interactive interface 502 may include a suite of action buttons at the bottom for managing the overall listing process: a previous button 514 for navigating back to earlier steps in the listing process, a save button 516 for preserving the current state of listings and modifications, a preview button 518 for reviewing how listings will appear to potential buyers, and a publish button 520 for finalizing and publishing the selected items on the platform. These controls ensure users can review and refine the system's automated processing of their polymodal input before publication.

In some examples, the terms “quantity,” “unit price,” and “total price” used herein may refer to numerical values associated with items to be published. The quantity may indicate the number of identical items available for sale, such as the three copies of Book A or five motor gears shown in the photo input 302. The unit price represents the price per individual item, while the total price is calculated by multiplying the quantity by the unit price. For example, as shown in FIG. 5, if Book A has a quantity of 2 and a unit price of 25, the total price would be 50. A user may set the unit price or the total price, and the system can automatically calculate and update the other.

In some examples, the system may calculate and display selected items'total prices and associated service fees. The total prices may be automatically calculated based on the quantities and unit prices of items selected for publication through the selectable options 508. Service fees may include platform fees, payment processing fees, or subscription tier-based fees.

The item elements, attributes, and organizational structures shown in the interactive interface 502 are provided as examples only and should not be considered limiting. The actual appearance, arrangement, and content of item elements may vary based on the specific implementation of the publication platform, the nature of the items being listed, and the type of polymodal input provided. The system may display different item elements and attributes based on various factors including but not limited to the category of items, the type of input provided (e.g., photos, videos, audio recordings), the semantic relationships identified between items, and the specific requirements of different types of listings on the publication platform.

In some examples, the term “item elements” used herein may refer to any characteristics, attributes, or information related to an item that can be extracted from polymodal input, including but not limited to physical characteristics (e.g., dimensions, weight), visual characteristics (e.g., color, shape, condition), descriptive information (e.g., title, brand, model), category information, pricing information, and any other relevant details that can be identified through processing of photos, videos, audio recordings, text, or other input formats.

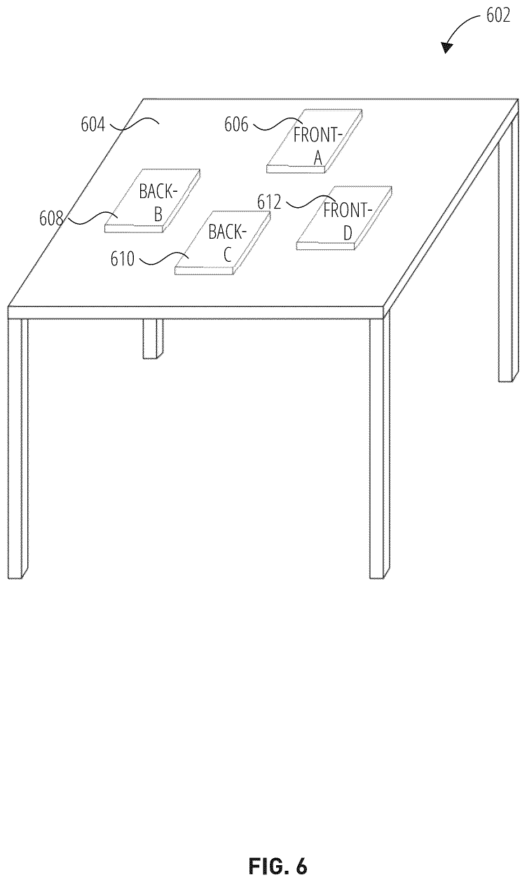

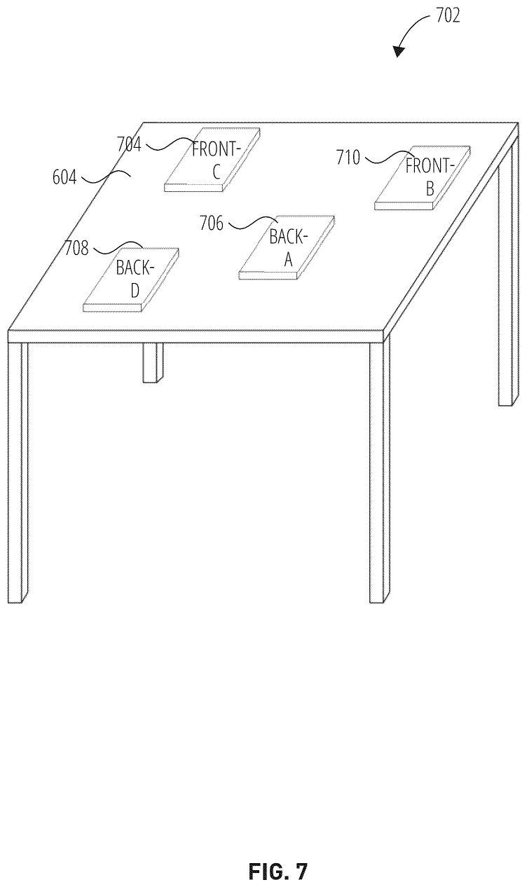

FIGS. 6 and 7 are example photo inputs 602 and 702 of front and back surfaces of items to be published on the publication platform, according to various examples of the present disclosure. FIG. 6 shows a photo input 602 taken of items placed on a table 604. The photo input 602 includes four player cards, namely a player card A, a player card B, a player card C, and a player card D. The player card A and player card D may show their front surfaces (FRONT-A 606 and FRONT-D 612). The player card B and player card C may show their back surfaces (BACK-B 608 and BACK-C 610). Unlike items such as motor gears or leather cleaners, whose value primarily depends on their specifications (and are relatively fixed), the value of player cards and similar collectible items can vary significantly based on their visual appearance and surface conditions.

FIG. 7 shows a subsequent photo input 702 of the same player cards after the user has flipped some cards to photograph their opposite surfaces. The photo input 702 shows the cards placed on the same table 604, but their positions and orientations have been changed. For example, front surface 704 of player card C corresponds to the back surface 610 of the same player card C.

The system can process these multiple photo inputs to identify and match the front and back surfaces of each player card, even when the cards are photographed in different positions or orientations. For example, the system can determine that the surfaces 704 and 610 represent different surfaces of the same player card, despite their different positions in the sequential photo inputs. The system's ability to match corresponding surfaces of the same item, even when photographed separately and in different arrangements, demonstrates how the trained AI models can identify and establish semantic relationships between different views of the same item. In some examples, the system uses visual features such as color patterns, textures, size, and edge detection to determine that surfaces 704 and 610 represent different surfaces of the same player card. The system may also query a database that stores surfaces of the player cards for reference. The model leverages convolutional neural networks (CNNs) to extract these features and spatial relationships between the two surfaces. Additionally, the system employs feature matching algorithms or key point detection methods, such as SIFT (Scale-Invariant Feature Transform) or SURF (Speeded-Up Robust Features), to find corresponding features across images. The system may either first identify the player card by comparing it with a database of known cards and then match the surfaces, or it may first match the surfaces of the cards and then identify the card based on the matched features. Alternatively, the system may identify the card without querying the database but merely based on the extracted text and/or image on the surfaces of the card.

This semantic grouping capability is important for creating comprehensive listings that accurately represent collectible items like player cards, where buyers need to assess both front and back surfaces to determine value.

Unlike conventional methods, which require users to carefully photograph and individually label both surfaces of each card one at a time, the system enables efficient bulk photo input processing. Users can take photos of different cards showing various surfaces in random arrangements, and the system automatically matches corresponding surfaces using trained AI models. This capability significantly streamlines the listing process for collectible items by eliminating the need for careful arrangement and individual photography of each item's surface. Instead, users can quickly photograph groups of items in any convenient arrangement, and the system will analyze the visual characteristics to establish semantic relationships between different views of the same item, enabling the automatic generation of complete listings that showcase all relevant surfaces.

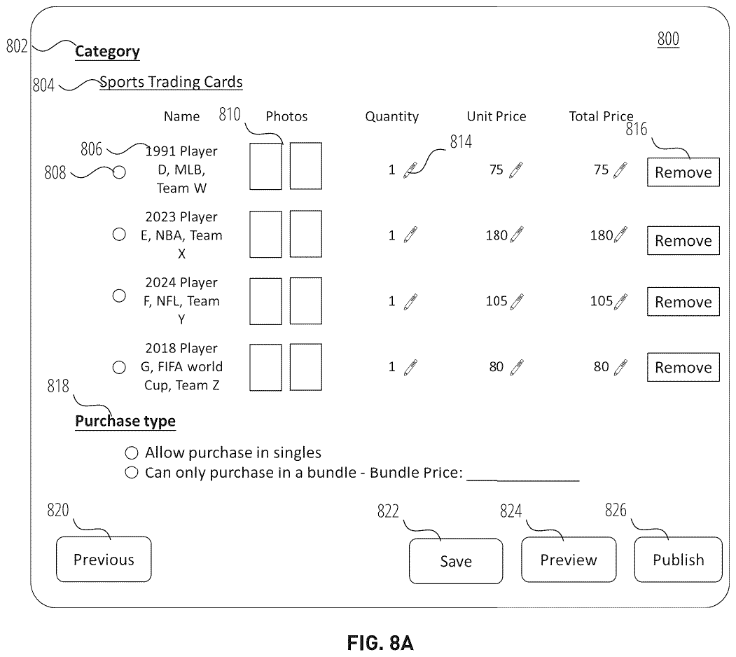

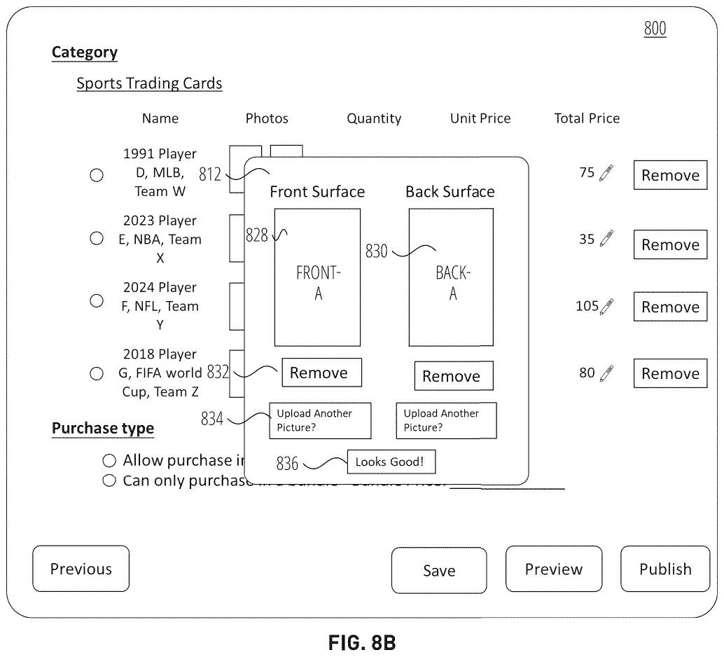

FIG. 8A is a diagram illustrating an example interactive interface 800 showing identified, grouped, and categorized items on the publication platform, according to various examples of the present disclosure.

The interactive interface 800 includes a main category section 802 that displays “Sports Trading Cards” 804 as the category heading. Within this section, the system displays individually recognized cards 806 that have been identified by querying a database based on their surfaces. For example, the system has identified “1991 Player D, MLB, Team W” and other player cards with their respective teams and years. Each card listing includes selectable options 808 for managing the listing, cropped photos 810 of card surfaces showing relevant views of the card. While the minimal size display shows two surfaces (typically front and back) for trading cards, the system can display more surfaces based on the item category. For example, items like shoes or electronics may display 4 or 6 surfaces to show different angles and details that are relevant to that particular category. A pen-shaped editing icon 814 for modifying details, and a remove button 816 for removing the item from the listing.

The interactive interface 800 includes a purchase type section 818 where users can specify whether items can be purchased individually or must be bought as a bundle. This option allows sellers to create flexible purchasing arrangements for their trading cards. The interface also provides navigation and action buttons at the bottom: a previous button 820 for returning to earlier steps, a save button 822 for preserving current progress, a preview button 824 for reviewing listings, and a publish button 826 for finalizing the listings.

FIG. 8B is a diagram illustrating an example popup interactive interface 812 showing enlarged views of the grouped surfaces of individual items, according to various examples of the present disclosure. The popup interactive interface 812 may be displayed when a user interacts with (e.g., clicks on) the corresponding cropped photo 810 of the item. The popup interface 812 displays detailed views of card surfaces, including the front surface 828 and back surface 830 of player card A. This detailed view enables sellers to verify that the system has correctly matched corresponding card surfaces.

The popup interactive interface 812 provides remove buttons 832 for each surface view, allowing sellers to remove incorrect or unwanted images. Upload buttons 834 enable users to replace current surface images with new pictures if needed. A “Looks Good!” button 836 allows users to confirm that the displayed surfaces are correctly matched and suitable for the listing.

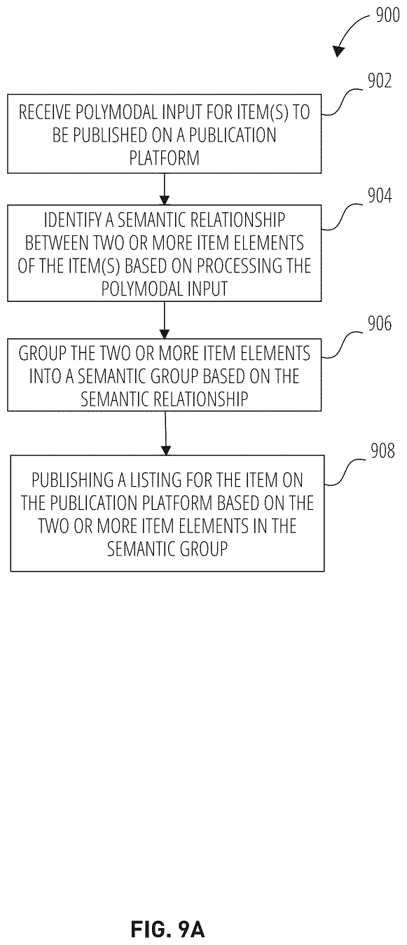

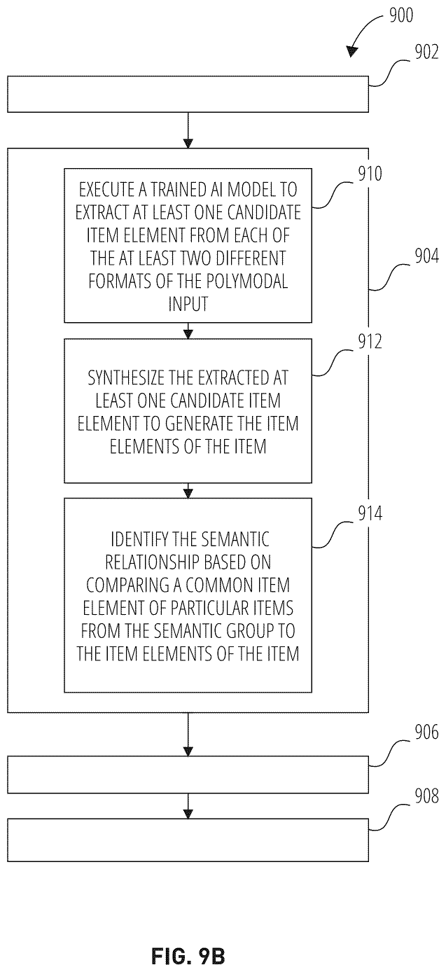

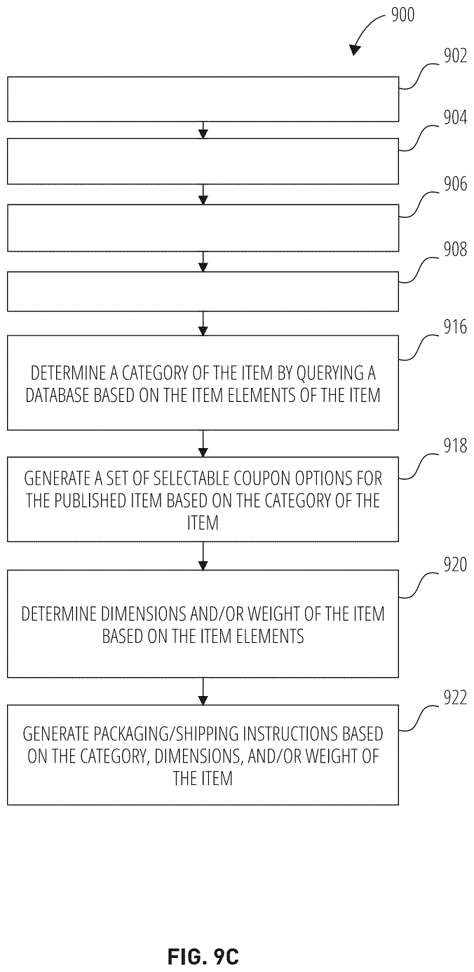

FIGS. 9A-9C are flowcharts illustrating an example method 900 for processing polymodal input and generating listings on the publication platform, according to various examples of the present disclosure. It will be understood that example methods described herein may be performed by a machine in accordance with some embodiments. For example, method 900 can be performed by the client device 102, the publication system 122, the server system 108, or individual components thereof. An operation of method 900 may be performed by one or more hardware processors (e.g., central processing units or graphics processing units) of a computing device (e.g., a desktop, server, laptop, mobile phone, tablet, etc.), which may be part of a computing system based on a cloud architecture. The method 900 may also be implemented in the form of executable instructions stored on a machine-readable medium or in the form of electronic circuitry. For instance, the operations of method 900 may be represented by executable instructions that, when executed by a processor of a computing device, cause the computing device to perform method 900. Depending on the embodiment, an operation of the method 900 may be repeated in different ways or involve intervening operations not shown. Though the operations of the method 900 may be depicted and described in a certain order, the order in which the operations are performed may vary among embodiments, including performing certain operations in parallel.

At operation 902, a system (e.g., the publication system 122) receives polymodal input for one or more items to be published on a publication platform. The polymodal input may include multiple formats such as photos, videos, audio recordings, text, spreadsheets, etc. For example, the polymodal input may include photos showing multiple items placed on a table and voice instructions specifying which items to sell, such as the photo input 302 and voice input 402 described earlier. As another example, the polymodal input may include two photos showing difference surfaces of items, such as the photo inputs 602 and 702 described earlier.

At operation 904, the system identifies a semantic relationship between two or more item elements of the items based on processing the polymodal input. The system uses trained AI models to analyze different types of input and extract relevant item elements. For example, when processing photos of trading cards, the system can identify relationships between front and back surfaces of the same card, even when photographed in different positions or arrangements. Details regarding the identification of the semantic relationship may be found in FIG. 9B and descriptions thereof.

At operation 906, the system groups the two or more item elements into a semantic group based on the semantic relationship. This grouping process organizes related item elements together, such as different surfaces of the same item and/or multiple items belonging to the same category. The semantic grouping enables the system to create comprehensive listings that accurately represent items with multiple views or related characteristics.

At operation 908, the system publishes a listing for the items on the publication platform based on the two or more item elements in the semantic group. The published listing includes relevant information extracted and organized through the previous operations, such as item descriptions, categories, quantities, and prices. The system may also prefill listing information by querying databases based on the identified item elements. In some examples, the system may prefill listing information including a title, a category, a description, etc. of the item based on semantically grouping the set of item elements in the semantic groups. The publication of the item may include the title, the category, the description, etc.

Refer to FIG. 9B, operation 904 may include three suboperations: 910, 912, and 914. At suboperation 910, the system executes a trained AI model to extract at least one candidate item element from each of the at least two different formats of the polymodal input. For example, the system can use image recognition models to identify individual items and their characteristics from photos or videos, while using natural language processing models to extract relevant information from audio recordings or text input. For image and video inputs, the trained AI model processes each frame to detect and isolate individual objects. For audio inputs, the natural language processing model converts speech to text and extracts relevant information about items and selling instructions. Different processing instructions can be provided to the AI model based on the input format being processed. For example, when processing trading card photos, the model(s) could be specifically instructed to identify card characteristics and match corresponding surfaces. The processing instructions for each type of input format may be predefined to the AI model, e.g., during the training process of the AI model. Alternatively, the processing instructions can be provided by the user together with the user input.

At suboperation 912, the system uses generative AI models (or large language models) such as Gemini and GPT-4, etc. to synthesize the extracted elements. These models can process multiple input types simultaneously (image, video, audio, text, spreadsheet) and combine the information based on specific instructions. When two different inputs both mention a certain term, the model can determine whether they are addressing the same or different items. The model can also search and correlate information of an item in one input with relevant information of the item in another input. For example, when processing a combination of photo and audio input, the system can merge visual item characteristics with verbal selling instructions to create comprehensive item descriptions.

At suboperation 914, the system identifies the semantic relationship based on comparing a common item element of particular items from the semantic group to the two or more item elements of the item. The model compares extracted elements against known patterns and relationships in the training data to identify connections between different views or aspects of the same item. For trading cards, the AI models of the system could have been trained on extensive card data when presented in different orientations. The system can identify relationships between front and back surfaces by comparing visual characteristics and matching corresponding surfaces, even when they appear in different photos or arrangements. The system may also compare the visual characteristics of the cards with existing surfaces stored in a database or their official website.

Refer to FIG. 9C, after the listing of the items on the publication platform, method 900 may proceed to operations 916, 918, 920, and 922.

At operation 916, the system determines a category of the item by querying a database based on item elements of the item. The system leverages its training on the publication platform's category tree and database to categorize items based on their identified characteristics automatically. In some examples, the operation 916 is performed before the operation 908 to ensure that the item is listed under a proper category.

At operation 918, the system generates a set of selectable coupon options for the published item based on the category of the item. For example, the system may generate coupon codes like “AUTO_PARTS20” for auto parts items or “KIDS_BOOKS10” for children's books. The seller can customize these auto-generated coupon codes, adjusting discount percentages or other details based on their preferences.

At operation 920, the system determines dimensions and/or weight of the item based on the item elements of the item. Using trained AI models, the system can analyze visual inputs to estimate physical characteristics of items. Alternatively, or additionally, the system may query a database for the dimensions and/or weight of the item.

At operation 922, the system generates packaging and shipping instructions based on the category, dimensions, and/or weight of the item. For example, the system can determine appropriate box sizes, recommend packaging materials (like bubble wrap or packaging peanuts), and provide step-by-step instructions for properly securing items for shipping. The system can also determine shipping options and costs based on these parameters. Merely by way of example, a fragile glass cup can be instructed to be packaged with a sturdy corrugated cardboard box that's larger than 5×5×6 inches with sufficient space to accommodate protective materials. The protective materials may include foam inserts, bubble wrap, packing peanuts, or air cushions. The packaging instructions for such glass cup may also include the locations in the box to place the glass cup at, and how the box can be taped and labeled. The shipping instruction for such glass cup may include the carrier, shipping speed, estimated price, etc. In some examples, the shipping instruction may be obtained from a database, a lookup table, or a pre-trained model.

In some examples, the system may extract user data from the publication platform or third-party platforms to enhance the listing process.

In some examples, the system may be free or charged. For example, the system can have multiple tiers of membership: silver tier, gold tier, platinum tier, etc. Each tier may have different upload limits. The system may determine a membership tier of the user associated with the publication platform and determine publishing conditions associated with that tier. If the user input does not satisfy the conditions (e.g., they have exceeded the monthly upload limit or size limit of the upload file), the system presents options to upgrade the membership tier or amend the input.

In some examples, the system generates marketing strategies for items based on historical sales data and current market conditions, including recommended listing prices. The system analyzes competitor trends and provides insights to help sellers optimize their listings, for example, by providing a supply-demand curve.

In some examples, when determining that multiple items have a common category, the system creates and publishes a combined listing of the items under that common category. For example, the books 306, including three Book A and two Book B are published as a combined listing under the common category “Book, Movies, & Music,” as explained in examples in FIG. 5.

In some examples, the system integrates with third-party APIs through, for example, an AI Chomsky Gateway or the like to provide additional services such as seller research capabilities, tax effective structuring, P&L statement generation, marketing strategy insights, financial management automation, competitor trend analysis, etc. For example, the system may analyze market data and competitor trends to provide actionable insights, e.g., selling a table and a chair in a bundle, selling at 95% of the listing price.

In some examples, the system provides a step-by-step interface for packaging instructions, rather than just text instructions. The interface allows users to progress through packaging steps sequentially using arrow keys or enter key, making the process more interactive and easier to follow.

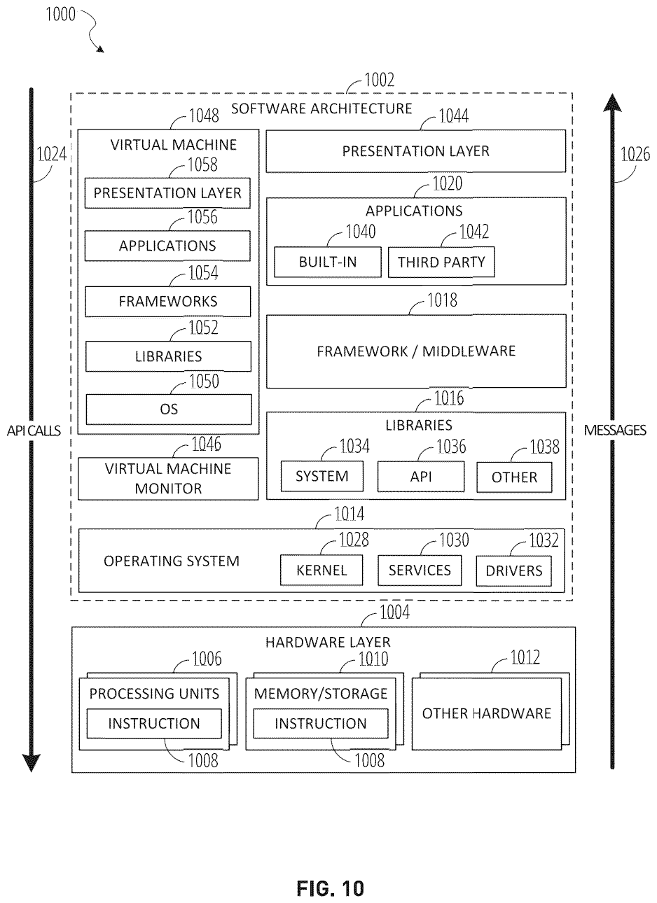

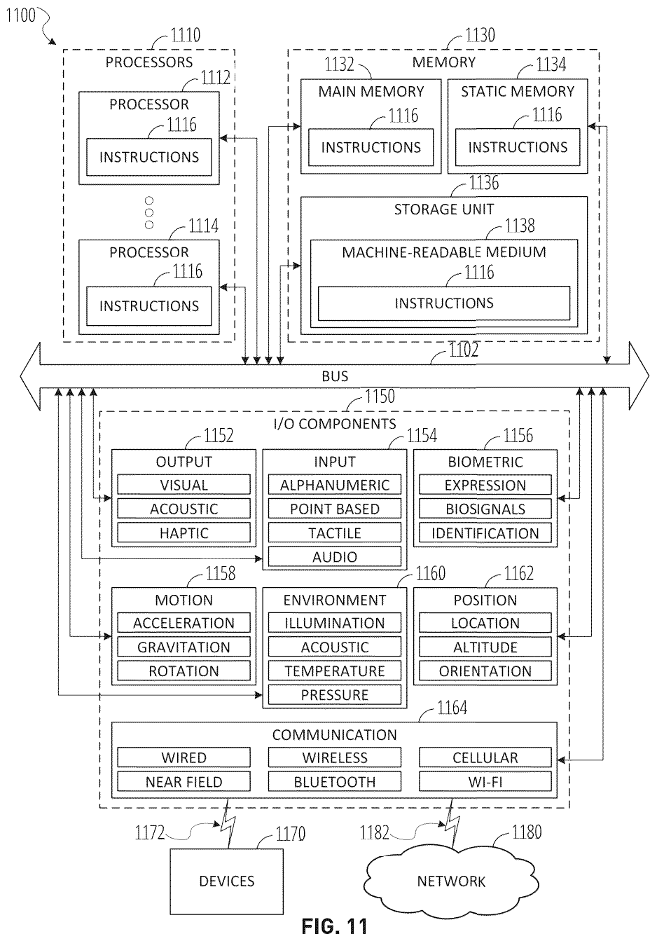

FIG. 10 is a block diagram illustrating an example of a software architecture 1002 that may be installed on a machine, according to some example embodiments. FIG. 10 is merely a non-limiting example of a software architecture 1000, and it will be appreciated that many other architectures may be implemented to facilitate the functionality described herein. The software architecture 1002 may be executing on hardware such as a machine 1100 of FIG. 11 that includes, among other things, processors 1110, memory 1130, and input/output (I/O) components 1150. A representative hardware layer 1004 is illustrated and can represent, for example, the machine 1100 of FIG. 11. The representative hardware layer 1004 comprises one or more processing units 1006 having associated executable instructions 1008. The executable instructions 1008 represent the executable instructions of the software architecture 1002. The hardware layer 1004 also includes memory or storage modules 1010, which also have the executable instructions 1008. The hardware layer 1004 may also comprise other hardware 1012, which represents any other hardware of the hardware layer 1004, such as the other hardware illustrated as part of the machine 1100.

In the example architecture of FIG. 10, the software architecture 1002 may be conceptualized as a stack of layers, where each layer provides particular functionality. For example, the software architecture 1002 may include layers such as an operating system 1014, libraries 1016, frameworks/middleware 1018, applications 1020, and a presentation layer 1044. Operationally, the applications 1020 or other components within the layers may invoke API calls 1024 through the software stack and receive a response, returned values, and so forth (illustrated as messages 1026) in response to the API calls 1024. The layers illustrated are representative in nature, and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 or other software components/modules. For example, the frameworks 1018 may provide various graphical user interface functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a home application, a contacts application, a browser application, a book reader application, a location application, a media application, a messaging application, or a game application.

The third-party applications 1042 may include any of the built-in applications 1040, as well as a broad assortment of other applications. In a specific example, the third-party applications 1042 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1042 may invoke the API calls 1024 provided by the mobile operating system such as the operating system 1014 to facilitate functionality described herein.

The applications 1020 may utilize built-in operating system functions (e.g., kernel 1028, services 1030, or drivers 1032), libraries (e.g., system libraries 1034, API libraries 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with the user.

Some software architectures utilize virtual machines. In the example of FIG. 10, this is illustrated by a virtual machine 1048. The virtual machine 1048 creates a software environment where applications/modules can execute as if they were executing on a hardware machine. The virtual machine 1048 is hosted by a host operating system (e.g., the operating system 1014) and typically, although not always, has a virtual machine monitor 1046, which manages the operation of the virtual machine 1048 as well as the interface with the host operating system (e.g., the operating system 1014). A software architecture executes within the virtual machine 1048, such as an operating system 1050, libraries 1052, frameworks 1054, applications 1056, or a presentation layer 1058. These layers of software architecture executing within the virtual machine 1048 can be the same as corresponding layers previously described or may be different.

FIG. 11 illustrates a diagrammatic representation of a machine 1100 in the form of a computer system within which a set of instructions may be executed for causing the machine 1100 to perform any one or more of the methodologies discussed herein, according to an embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute the method 900 described above with respect to FIGS. 9A-9C. 5. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an embodiment, the processors 1110 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory 1130 may include a main memory 1132, a static memory 1134, and a storage unit 1136 including machine-readable medium 1138, each accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion, and the grouping is in no way limiting. In some examples, the I/O components 1150 may include output components 1152 and input components 1154. The output components 1152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 1150 may include biometric components 1156, motion components 1158, environmental components 1160, or position components 1162, among a wide array of other components. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 1100 including processors 1110), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 1100, but deployed across a number of machines 1100. In some example embodiments, the processors 1110 or processor-implemented modules are located in a single geographic location (e.g., within a home environment, an office environment, or a server farm). In other example embodiments, the processors or processor-implemented modules are distributed across a number of geographic locations.

The various memories and/or the storage unit 1136 may store one or more sets of instructions 1116 and data structures (e.g., software) embodying or utilized by any one or more of the methodologies or functions described herein. These instructions (e.g., the instructions 1116), when executed by the processor(s), cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1008 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below. As such, these terms are non-transitory.

In some examples, one or more portions of the network 1180 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

Described implementations of the subject matter can include one or more features, alone or in combination, as illustrated below by way of example.

Example 1. A system comprising: one or more hardware processors; and at least one machine-storage medium storing instructions that, when executed by the one or more hardware processors, cause the system to perform operations comprising: receiving, from an interactive interface of a publication platform, input comprising information about an item to be published on the publication platform, the information about the item comprising item elements related to the item; identifying a semantic relationship between two or more of the item elements related to the item based on receiving the input; grouping the two or more item elements into a semantic group based on the semantic relationship; and generating a listing for the item on the publication platform based on the two or more item elements in the semantic group.

Example 2. The system of example 1, wherein the input is a polymodal input comprising at least two formats selected from a group consisting of an image, a video, an audio recording, text, and a spreadsheet and the operations further comprise: processing the at least two formats of the polymodal input to identify the semantic relationship.

Example 3. The system of example 2, wherein the processing the at least two formats of the polymodal input to identify the semantic relationship comprises: executing a trained artificial intelligence (AI) model to extract at least one candidate item element from each of the at least two formats of the polymodal input and to synthesize the extracted at least one candidate item element corresponding to the each of the at least two formats of the polymodal input to generate the item elements related to the item.

Example 4. The system of example 3, wherein the executing the trained AI model to extract at least one candidate item element from each of the at least two formats of the polymodal input comprises: providing a different processing instruction to the trained AI for each of the at least two formats of the polymodal input.

Example 5. The system of any of examples 1-4, wherein the identifying the semantic relationship comprises: processing, using a multi-modal large language model, the information comprising a first item element related to the item, the first item element having a first format; and processing, using the multi-modal large language model, the information comprising a second item element related to the item, the second item element having a second format that is different from the first format.

Example 6. The system of any of examples 1-5, wherein the semantic relationship is based on the two or more item elements being on different surfaces of the item, and wherein the grouping further comprises: determining that the item has a first item element on a first surface of the item and a second item element on a second surface of the item; and grouping the first item element and the second item element into the semantic group.

Example 7. The system of any of examples 1-6, wherein the operations further comprise: receiving a polymodal input for a second item; identifying a set of item elements from the polymodal input for the second item using an artificial intelligence (AI) model trained to extract item elements from the polymodal input; and semantically grouping the set of item elements into semantic groups.

Example 8. The system of example 7, wherein the operations further comprise: prefilling listing information including a title, a category, and a description of the second item based on semantically grouping the set of item elements in the semantic groups; and publishing the second item, the publication including the title, the category, and the description.

Example 9. The system of any of examples 1-8, wherein the operations further comprise: determining a category of the item by querying a database based on the one or more item elements in the semantic group; and publishing the item on the publication platform by prefilling listing information of the item that includes the category.

Example 10. The system of example 9, wherein the operations further comprise: determining dimensions for the item and a weight of the item based on the one or more item elements of the item; generating packaging instructions for the item based on the category, the dimensions, and the weight of the item; and presenting, on the interactive interface, the packaging instructions for the item.

Example 11. A method comprising: receiving polymodal input for an item to be published on a publication platform, the polymodal input having at least two different formats; identifying a semantic relationship between two or more item elements of the item based on processing the polymodal input; grouping the two or more item elements into a semantic group based on the semantic relationship; and publishing a listing for the item on the publication platform based on the two or more item elements in the semantic group.

Example 12. The method of example 11, further comprising: identifying the semantic relationship based on comparing a common item element of particular items from the semantic group to the two or more item elements of the item, and grouping the two or more item elements into the semantic group based on comparing the common item element.

Example 13. The method of example 11 or 12, wherein the processing the polymodal input comprises: executing a trained artificial intelligence (AI) model to extract at least one candidate item element from each of the at least two different formats of the polymodal input; and synthesizing the extracted at least one candidate item element to generate the two or more item elements of the item.

Example 14. The method of example 13, wherein the executing the trained AI model comprises: providing different processing instructions to the trained AI model for each of the at least two different formats of the polymodal input.

Example 15. The method of any of examples 11-14, wherein the identifying the semantic relationship comprises: processing, using a multi-modal large language model, a first item element having a first format; and processing, using the multi-modal large language model, a second item element having a second format different from the first format.

Example 16. The method of any of examples 11-15, wherein the semantic relationship is based on the two or more item elements being on different surfaces of the item, and wherein the grouping comprises: determining that the item has a first item element on a first surface and a second item element on a second surface; and grouping the first item element and the second item element into the semantic group.

Example 17. The method of any of examples 11-16, further comprising: receiving a polymodal input for a second item; identifying a set of item elements from the polymodal input for the second item using an artificial intelligence (AI) model trained to extract item elements from the polymodal input; and semantically grouping the set of item elements into semantic groups.

Example 18. The method of any of examples 11-17, further comprising: determining a category of the item by querying a database based on the two or more item elements in the semantic group; prefilling listing information including a title and a description based on the category; and publishing the listing including the title and the description.

Example 19. The method of example 18, further comprising: determining dimensions and weight of the item based on the two or more item elements; generating packaging instructions based on the category, dimensions, and weight; and presenting the packaging instructions on an interactive interface.

Example 20. A non-transitory machine-storage medium storing instructions that, when executed by one or more hardware processors, cause the one or more hardware processors to perform operations comprising: receiving, from an interactive interface of a publication platform, input comprising information about an item to be published on the publication platform, the information about the item comprising item elements related to the item; identifying a semantic relationship between two or more of the item elements related to the item based on receiving the input; grouping the two or more item elements into a semantic group based on the semantic relationship; and publishing a listing for the item on the publication platform based on the two or more item elements in the semantic group.

What is claimed is:

1. A system comprising:
one or more hardware processors; and
at least one machine-storage medium storing instructions that, when executed by the one or more hardware processors, cause the system to perform operations comprising:
receiving, from an interactive interface of a publication platform, input comprising information about an item to be published on the publication platform, the information about the item comprising item elements related to the item;
in response to receiving the input, identifying a semantic relationship between two or more of the item elements related to the item;
grouping the two or more item elements into a semantic group based on the semantic relationship; and
generating a listing for the item on the publication platform based on the two or more item elements in the semantic group.

2. The system of claim 1, wherein the input is a polymodal input comprising at least two formats selected from a group consisting of an image, a video, an audio recording, text, and a spreadsheet and the operations further comprise:
processing the at least two formats of the polymodal input to identify the semantic relationship.

3. The system of claim 2, wherein the processing the at least two formats of the polymodal input to identify the semantic relationship comprises:
executing a trained artificial intelligence (AI) model to extract at least one candidate item element from each of the at least two formats of the polymodal input and to synthesize the extracted at least one candidate item element corresponding to the each of the at least two formats of the polymodal input to generate the item elements related to the item.

4. The system of claim 3, wherein the executing the trained AI model to extract at least one candidate item element from each of the at least two formats of the polymodal input comprises:
providing a different processing instruction to the trained AI for each of the at least two formats of the polymodal input.

5. The system of claim 1, wherein the identifying the semantic relationship comprises:
processing, using a multi-modal large language model, the information comprising a first item element related to the item, the first item element having a first format; and
processing, using the multi-modal large language model, the information comprising a second item element related to the item, the second item element having a second format that is different from the first format.

6. The system of claim 1, wherein the semantic relationship is based on the two or more item elements being on different surfaces of the item, and wherein the grouping further comprises:
determining that the item has a first item element on a first surface of the item and a second item element on a second surface of the item; and
grouping the first item element and the second item element into the semantic group.

7. The system of claim 1, wherein the operations further comprise:
receiving a polymodal input for a second item;
identifying a set of item elements from the polymodal input for the second item using an artificial intelligence (AI) model trained to extract item elements from the polymodal input; and
semantically grouping the set of item elements into semantic groups.

8. The system of claim 7, wherein the operations further comprise:
prefilling listing information including a title, a category, and a description of the second item based on semantically grouping the set of item elements in the semantic groups; and
publishing the second item, the publication including the title, the category, and the description.

9. The system of claim 1, wherein the operations further comprise:
determining a category of the item by querying a database based on the one or more item elements in the semantic group; and
publishing the item on the publication platform by prefilling listing information of the item that includes the category.

10. The system of claim 9, wherein the operations further comprise:
determining dimensions for the item and a weight of the item based on the one or more item elements of the item;
generating packaging instructions for the item based on the category, the dimensions, and the weight of the item; and
presenting, on the interactive interface, the packaging instructions for the item.

11. A method comprising:
receiving polymodal input for an item to be published on a publication platform, the polymodal input having at least two different formats;
identifying a semantic relationship between two or more item elements of the item based on processing the polymodal input;
grouping the two or more item elements into a semantic group based on the semantic relationship; and
publishing a listing for the item on the publication platform based on the two or more item elements in the semantic group.

12. The method of claim 11, further comprising:
identifying the semantic relationship based on comparing a common item element of particular items from the semantic group to the two or more item elements of the item, and
grouping the two or more item elements into the semantic group based on comparing the common item element.

13. The method of claim 11, wherein the processing the polymodal input comprises:
executing a trained artificial intelligence (AI) model to extract at least one candidate item element from each of the at least two different formats of the polymodal input; and
synthesizing the extracted at least one candidate item element to generate the two or more item elements of the item.

14. The method of claim 13, wherein the executing the trained AI model comprises:
providing different processing instructions to the trained AI model for each of the at least two different formats of the polymodal input.

15. The method of claim 11, wherein the identifying the semantic relationship comprises:
processing, using a multi-modal large language model, a first item element having a first format; and
processing, using the multi-modal large language model, a second item element having a second format different from the first format.

16. The method of claim 11, wherein the semantic relationship is based on the two or more item elements being on different surfaces of the item, and wherein the grouping comprises:
determining that the item has a first item element on a first surface and a second item element on a second surface; and
grouping the first item element and the second item element into the semantic group.

17. The method of claim 11, further comprising:
receiving a polymodal input for a second item;
identifying a set of item elements from the polymodal input for the second item using an artificial intelligence (AI) model trained to extract item elements from the polymodal input; and
semantically grouping the set of item elements into semantic groups.

18. The method of claim 11, further comprising:
determining a category of the item by querying a database based on the two or more item elements in the semantic group;
prefilling listing information including a title and a description based on the category; and
publishing the listing including the title and the description.

19. The method of claim 18, further comprising:
determining dimensions and weight of the item based on the two or more item elements;
generating packaging instructions based on the category, dimensions, and weight; and
presenting the packaging instructions on an interactive interface.

20. A machine-storage medium storing instructions that, when executed by one or more hardware processors, cause the one or more hardware processors to perform operations comprising:
receiving, from an interactive interface of a publication platform, input comprising information about an item to be published on the publication platform, the information about the item comprising item elements related to the item;
identifying a semantic relationship between two or more of the item elements related to the item based on receiving the input;
grouping the two or more item elements into a semantic group based on the semantic relationship; and
publishing a listing for the item on the publication platform based on the two or more item elements in the semantic group.
